(19) United States
(12) Patent Application Publication
(10) Pub. No.: US 2019/0190408 A1
(43) Pub. Date: Jun. 20, 2019

(54) ELECTRIC SPEED CONTROLLER, FLIGHT CONTROLLER, AND CONTROL METHOD AND CONTROL SYSTEM OF UNMANNED AERIAL VEHICLE

(71) Applicant: SZ DJI TECHNOLOGY CO., LTD., Shenzhen (CN)

(72) Inventors: Qiu LAN, Shenzhen (CN); Changxing ZHOU, Shenzhen (CN); Wanqi LIU, Shenzhen (CN)

(21) Appl. No.: 16/284,376

(22) Filed: Feb. 25, 2019

Related U.S. Application Data
(63) Continuation of application No. PCT/CN2016/097355, filed on Aug. 30, 2016.

(51) Int. Cl. H02P 5/46; B64C 39/02; B64C 27/08; G05D 1/10

(52) U.S. Cl. CPC H02P 5/46; B64C 39/024; B64C 2201/042; G05D 1/101; B64C 2201/108; B64C 27/08

(57) ABSTRACT

A method for controlling an electric speed controller includes receiving an addressing instruction from a flight controller. The addressing instruction is used for addressing the electric speed controller with a target addressing number. The method further includes determining whether a throttle characteristic signal is received, and, if the throttle characteristic signal is received, sending a feedback signal for responding to the addressing instruction and recording the target addressing number according to the addressing instruction.

### CROSS-REFERENCE TO RELATED APPLICATION

This application is a continuation application of International Application No. PCT/CN2016/097355, filed on Aug. 30, 2016, the entire contents of which are incorporated herein by reference.

### TECHNICAL FIELD

The present disclosure relates to the field of unmanned aerial vehicle (UAV) and, more particularly, to an electric speed controller, a flight controller, a UAV control method, and a UAV control system.

### BACKGROUND

In the unmanned aerial vehicle (UAV) technology, a flight controller refers to a UAV controller, which mainly includes a gyroscope for flight attitude sensing, an accelerometer, a earth inductor, an air pressure sensor for hover control, and a control circuit. The power system includes a motor and an electric speed controller (ESC). The ESC is an electronic speed regulator that controls a motor rotation speed and stabilizes a voltage.

The fight controller may communicate with the ESC through the flight controller, the ESC may control the rotation speed of the motor, and the rotation of the motor(s) may cause propeller(s) to rotate, such that a flight of the UAV may be achieved. Communication approaches for the flight controller and ESC may include connecting the flight controller to the ESC through a throttle control signal line. A signal transmitted through the throttle control signal line may include a pulse width modulation (PWM) signal sent by the flight controller that has a fixed frequency and a variable time duration of high electric level. The variable time duration of high electric level may usually range from approximately 1000 μs to approximately 2000 μs. The longer the time duration of high electric level, i.e., the high pulse width, the faster the rotation speed of the motor driven by the ESC. Communication approaches for the flight controller and ESC may also include connecting the flight controller to the ESC through a universal asynchronous receiver/transmitter (UART) communication line. The flight controller and the ESC performs data exchange through the UART. The UART is a bus connection, and one UART of the flight controller may be connected to a plurality of ESCs. For ESCs to respond, the plurality of the ESCs need to be distinguished and assigned with numbers. That is, each ESC needs to be provided with a corresponding address. Further, the address need to be unique. Otherwise, two ESCs having a same address may respond to a same data package of the flight controller, resulting in bus conflicts.

In conventional technologies, in order to avoid bus conflicts, the plurality of ESCs need to be distinguished. Different programs are recorded in the plurality of ESCs, such that each ESC only responds to one type of data package sent by the flight controller.

However, programs are recorded in advance for a plurality of ESCs in different types of UAVs such as four-axis, six-axis and vector control UAVs, and the identification number of each ESC are determined. Thus, each ESC is installed only at a predefined motor position. For example, ESC No. 1 needs to be installed in a predefined motor position No. 1. If ESC No. 1 is installed at other motor positions, dangerous problems such as reverse rotation of the propeller may occur. Thus, for a safe flight of the UAV, during subsequent assembling, manufacturing, and repairing of the UAV, the numbered ESC needs to be strictly installed to the corresponding motor position, causing UAV manufacturing, assembling, and repairing processes relatively difficult.

### SUMMARY

In accordance with the disclosure, there is provided a method for controlling an electric speed controller including receiving an addressing instruction from a flight controller. The addressing instruction is used for addressing the electric speed controller with a target addressing number. The method further includes determining whether a throttle characteristic signal is received, and, if the throttle characteristic signal is received, sending a feedback signal for responding to the addressing instruction and recording the target addressing number according to the addressing instruction

Also in accordance with the disclosure, there is provided a control method for a flight controller including sending one or more addressing instructions to one or more electric speed controllers, respectively. The one or more addressing instructions are used for addressing the one or more electric speed controllers with one or more target addressing numbers, respectively. The method further includes sending a throttle characteristic signal to a target electric speed controller of the one or more electric speed controllers that is expected to be addressed, determining whether a feedback signal sent from the target electric speed controller is received, and, if the feedback signal is received, registering an addressing number of the target electric speed controller as one of the one or more target addressing numbers.

### BRIEF DESCRIPTION OF THE DRAWINGS

FIG. 1 is a schematic view of an exemplary unmanned aerial vehicle (UAV) consistent with various disclosed embodiments of the present disclosure.

FIG. 2 is a flowchart of an exemplary control method for an electric speed controller and a flight controller in an interaction manner consistent with various disclosed embodiments of the present disclosure.

FIG. 3 is a flowchart of another exemplary control method for an electric speed controller and a flight controller in an interaction manner consistent with various disclosed embodiments of the present disclosure.

FIG. 4 is a block diagram of an exemplary control system of electric speed controller consistent with various disclosed embodiments of the present disclosure.

FIG. 5 is a block diagram of an exemplary control system of flight controller consistent with various disclosed embodiments of the present disclosure.

FIG. 6 is a block diagram of an exemplary electric speed controller consistent with various disclosed embodiments of the present disclosure.

FIG. 7 is a block diagram of an exemplary flight controller consistent with various disclosed embodiments of the present disclosure.

FIG. 8 is a block diagram of an exemplary control system of UAV consistent with various disclosed embodiments of the present disclosure.

FIG. 9 is a block diagram of an exemplary UAV consistent with various disclosed embodiments of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In the present disclosure, the disclosed embodiments and the features of the disclosed embodiments may be combined under conditions without conflicts.

Exemplary embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

The present disclosure provides an electric speed controller (ESC), a flight controller, an unmanned aerial vehicle (UAV) control method, and a UAV control system, for suppressing potential safety hazard of the UAV caused by ESC installation and for relatively convenient installation of ESCs during manufacturing, assembling and repairing of UAVs.

An exemplary system structure or scenario of the present disclosure is described below.

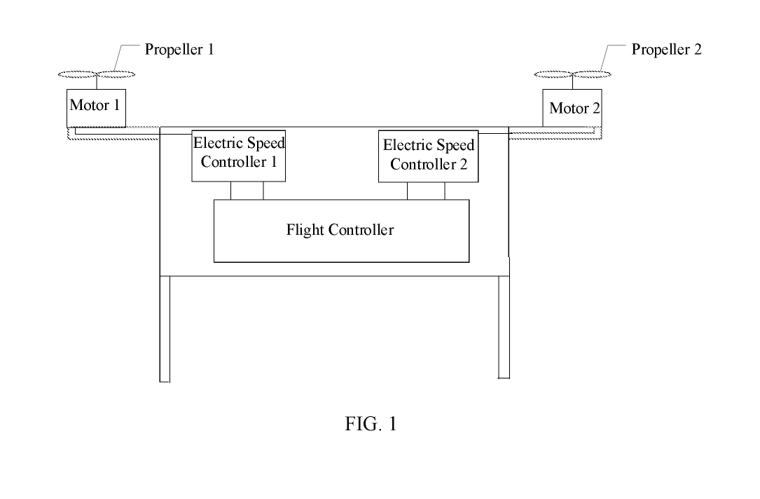

FIG. 1 is a schematic view of an exemplary unmanned aerial vehicle (UAV) consistent with various disclosed embodiments of the present disclosure. As shown in FIG. 1, the UAV includes a control system and a flight power apparatus. The flight power apparatus includes a motor 1, a propeller 1 corresponding to the motor 1, a motor 2, and a propeller 2 corresponding to the motor 2. A 2-axis UAV is described here merely for exemplary and illustrative purposes and is not intended to limit the scope of the present disclosure. Other types of UAVs such as single-axis UAVs, 4-axis UAVs, six-axis UAVs, or vector control UAVs may be chosen according to various application scenarios. The rotation of a motor may cause a propeller to rotate to provide flight power for the UAV. The rotation speeds of the motors may be controlled through communications between a flight controller of the UAV control system and ESC 1/ESC 2. The motor 1 corresponds to the ESC 1. The motor 2 corresponds to the ESC 2.

In conventional technologies, in order to maintain smooth flight, steering, take-off and landing of the UAV, each motor needs to be controlled at a certain rotation speed. In order for the flight controller to control the two motors, the ESCs corresponding to the two motors may need different programs recorded in advance and may need numbering. Accordingly, the flight controller can send throttle control signals according to flight instructions, and ESCs may control rotation speeds of the corresponding motors. The UAV can achieve smooth flight, steering, take-off, and/or other activities according to the flight instructions. Correspondingly, an ESC may need to be connected to a corresponding motor according to a preset number. For example, if an identification number of an ESC is 1, an original installation position may correspond to a motor 1. However, an installation error may occur, and the installation position may be changed to a motor 2. Thus, in response to the flight controller sending a throttle control signal in order to to cause the propeller 1 to rotate, because the motor 1 is connected to the ESC 2, the propeller 1 may not rotate, and the propeller 2 corresponding to the motor 2 may rotate. The UAV cannot follow instructions of the flight controller to perform a flight, and a risk of reverse propeller may occur. In the UAV manufacturing, assembling and repairing processes, the assembling staff need to perform assembling strictly in accordance with the identification number of the ESC, resulting in relatively inconvenient installation.

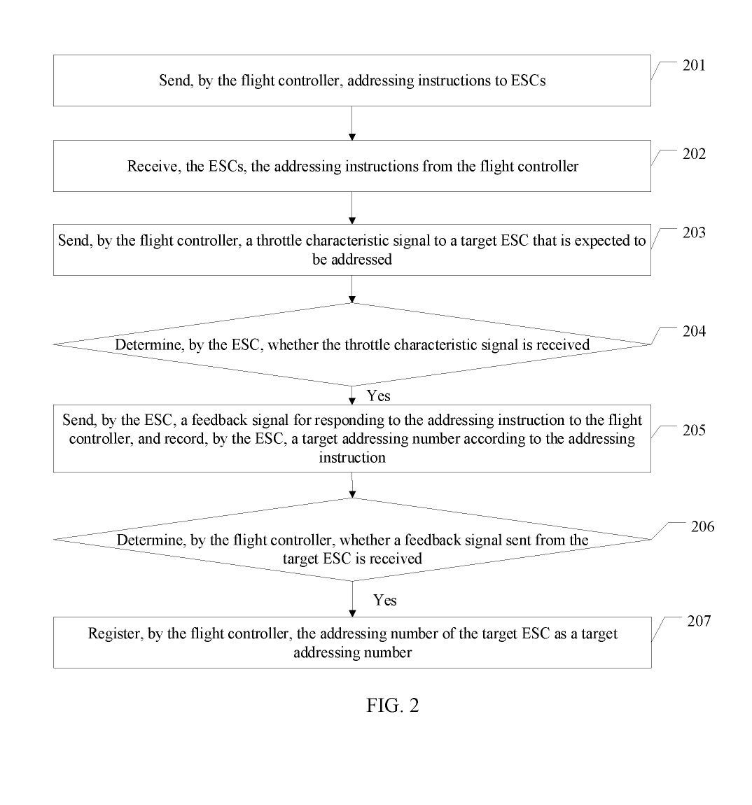

Directed to solve the above-mentioned problems, the present disclosure provides an electric speed controller, a flight controller, and a UAV control method and a UAV control system for addressing ESCs. With reference to FIG. 2, example embodiments of interactions between the electric speed controller and the flight controller are described in detail below.

At 201, the flight controller sends addressing instructions to ESCs.

In some embodiments, since the plurality of ESCs are not addressed when the UAV is initially powered on, the flight controller may need to address the ESCs in the UAV prior to the flight. The flight controller may send addressing instructions to the ESCs. The addressing instructions may address the ESCs, such that the ESCs may be assigned with target addressing numbers. The flight controller may be connected to the electric speed controllers through universal asynchronous receiver/transmitter (UART) communication lines. The flight controller and the electric speed controllers may perform data exchange through the UART. The UART communication line may include a bus connection, and addressing instructions may be sent, e.g., issued, through the UART communication lines. The ESCs can receive the addressing instructions. The above-described UART communication line is taken as an example of data line for the bus merely for illustrative purposes. Other types of data lines may be adopted for the bus, which are not restricted in the present, and may be chosen according to various application scenarios.

At 202, the ESCs receive the addressing instructions from the flight controller.

In some embodiments, the ESCs may receive the addressing instructions sent by the flight controller through the UART communication lines. However, the ESCs may not power on and may not execute the addressing instructions, until the ESCs receive throttle characteristic signals.

At 203, the flight controller sends a throttle characteristic signal to a target ESC that is expected to be addressed.

In some embodiments, because a plurality of ESCs exist, in order to distinguish the ESCs from each other, the addressing numbers of the ESCs need to be different. After the addressing instructions are sent, one of the plurality of ESCs may need to be provided with a throttle characteristic signal in order to address the one of the plurality of ESCs. One throttle control signal line may be provided between the flight controller and each ESC. The throttle control signal line may include a pulse width modulation (PWM) signal line. Thus, the flight controller may send the throttle characteristic signal to the expected-to-be-addressed (ETBA) target ESC through a PWM signal line.

At 204, the ESC determines whether the throttle characteristic signal is received. Process 205 is performed in response to the throttle characteristic signal being received.

In some embodiments, the ESC may detect whether the throttle characteristic signal sent by the flight controller is received through the throttle control signal line. In response to the throttle characteristic signal being received, it may indicate that the ESC is the target ESC, and process 205 may be performed. In response to the throttle characteristic signal not being received, it may indicate that the ESC is not the target ESC.

At 205, the ESC sends a feedback signal for responding to the addressing instruction to the flight controller, and records a target addressing number according to the addressing instruction.

In some embodiments, after the ESC receives the throttle characteristic signal, which indicates that the ESC is the target ESC, the ESC may perform the addressing instruction and send a feedback signal for responding to the addressing instruction to the flight controller, and may record a target addressing number according to the addressing instruction. Correspondingly, the addressing of the ESC may be completed, and the ESC may have obtain its own target addressing number.

At 206, the flight controller determines whether a feedback signal sent from the target ESC is received. Process 207 is performed in response to the feedback signal being received.

In some embodiments, after the flight controller sends the throttle characteristic signal, it may need to be determined whether the target electric speed controller is addressed. Thus, the flight controller may need to detect whether the feedback signal sent from the target electric speed controller is received, and perform process 207 in response to receiving the feedback signal.

At 207, the flight controller registers the addressing number of the target ESC as a target addressing number.

In some embodiments, receipt of the feedback signal from the target ESC by the flight controller may indicate that the target ESC has been successfully addressed. Accordingly, the flight controller may register the addressing number of the target ESC as a target addressing number, complete addressing the target ESC, and address each ESC according to a same or similar manner.

Consistent with the present disclosure, a flight controller may send addressing instructions to ESCs, and the addressing instructions may address the ESCs, such that the ESCs are assigned with target addressing numbers. The ESCs may receive the addressing instructions from the flight controller. The flight controller may send a throttle characteristic signal to an ETBA target ESC. The ESC may determine whether the throttle characteristic signal is received. If so, it may be determined that the ESC is the target ESC, and the ESC may send a feedback signal for responding to the addressing instruction to the flight controller, and may record a target addressing number according to the addressing instruction. The flight controller may determine whether the feedback signal sent from the target ESC is received. If so, the flight controller may register the addressing number of the target ESC as a target addressing number. In the present disclosure, the flight controller can address the ESC at a later stage without a need to install a numbered ESC in a corresponding motor position, as compared to conventional technologies. Accordingly, the safety hazard of UAV caused by the installation of ESCs may be suppressed, and the installation of ESCs in the UAV manufacturing, assembling, and repairing processes may be relatively convenient.

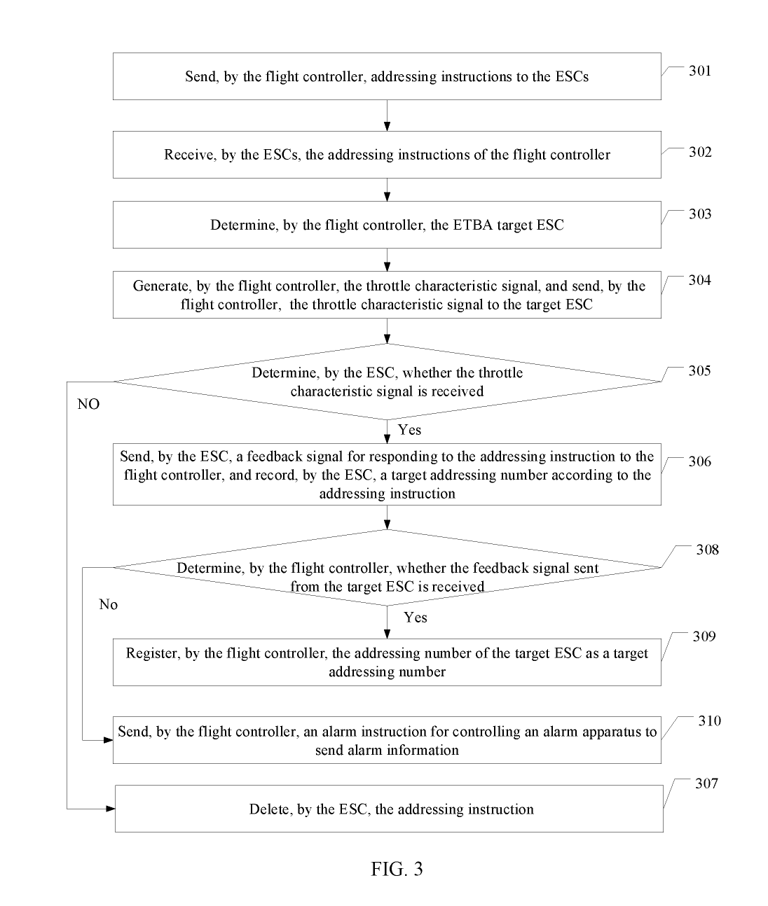

In the embodiments of the disclosure, the ESC may be addressed via the flight controller sending the throttle characteristic signal to the ETBA target ESC. This process is described in more detail below with reference to FIG. 3.

At 301, the flight controller sends addressing instructions to the ESCs.

For details, reference can be made to the descriptions of process 201.

At 302, the ESCs receive the addressing instructions of the flight controller.

For details, reference can be made to the descriptions of process 202.

At 303, the flight controller determines the ETBA target ESC.

In some embodiments, because a plurality of ESCs exist, in order to distinguish the ESCs, addressing numbers of the ESCs need to be different from each other. After the addressing instructions are sent, one of the plurality of ESCs may need to be provided with a throttle characteristic signal in order to address the one of the plurality of ESCs.

At 304, the flight controller generates the throttle characteristic signal and sends the throttle characteristic signal to the target ESC.

In some embodiments, after the target ESC is determined, the throttle characteristic signal may be generated, and may be sent to the target ESC.

At 305, the ESC determines whether the throttle characteristic signal is received. The ESC performs process 306 in response to the throttle characteristic signal being received, and performs process 307 in response to the throttle characteristic signal not being received.

In some embodiments, the ESC may detect whether the throttle characteristic signal sent from the flight controller is received through the throttle control signal line. If so, it may indicate that the ESC is the target ESC, and process 306 is performed. If not, it may indicate that the ESC is not the target ESC, and process 307 is performed.

At 306, the ESC sends a feedback signal for responding to the addressing instruction to the flight controller, and records a target addressing number according to the addressing instruction.

For details, reference can be made to the descriptions of process 205.

At 307, the ESC deletes the addressing instruction.

In some embodiments, if the ESC determines that the throttle characteristic signal is not received, it may indicate that the ESC is not the target ESC, and thus the addressing instruction received previously may not be executed. In order to reduce the memory occupation of the ESC, the addressing instruction may be deleted.

At 308, the flight controller determines whether the feedback signal sent from the target ESC is received. The flight controller performs process 309 in response to the flight controller receiving the feedback signal, and performs process 310 in response to the flight controller not receiving the feedback signal.

In some embodiments, after the flight controller sends the throttle characteristic signal, it may need to be determined whether the target electric speed controller is addressed. Thus, the flight controller may need to determine whether the feedback signal from the target electric speed controller is received, and perform process 309 in response to receiving the feedback signal, and perform process 310 in response to not receiving the feedback signal.

At 309, the flight controller registers the addressing number of the target ESC as a target addressing number.

For details, reference can be made to the descriptions of process 207.

At 310, the flight controller sends an alarm instruction for controlling an alarm apparatus to send alarm information.

In some embodiments, the flight controller not receiving the feedback signal sent from the target ESC may indicate that the addressing of the target ESC fails. Correspondingly, the UAV may be in danger. The flight controller may need to send an alarm instruction for controlling an alarm apparatus to send alarm information, to prompt the user that there is danger at this time and the UAV cannot be operated for flight.

In the embodiments of the present disclosure, descriptions are made for the determination of the ETBA target ESC. Further, a process of deleting the addressing instruction in response to the ESC not receiving the throttle characteristic signal may be added, and an alarm process in response to the flight controller not receiving the feedback signal may be added, such that storage space of the electric speed controller may be saved during the implementation of the present disclosure, and the UAV may be relatively safe.

In the above-described embodiments, the process 306 includes the ESC providing feedback for the addressing instruction and recording the target addressing number, and may include a plurality of processes, as described in detail below.

The he process 306 may include executing addressing instructions to perform addressing according to the throttle characteristic signal to obtain the target addressing number; generating a feedback signal according to the addressing instruction; sending the feedback signal to the flight controller; and recording the target addressing number.

Consistent with embodiments of the disclosure, receipt of the throttle characteristic signal by an ESC may indicate that the ESC is the target ESC and the addressing instruction received previously may need to be executed. A target addressing number of the ESC may be obtained through addressing. Further, during addressing, a feedback signal may need to be generated. The feedback signal may be sent to the flight controller through the UART communication line to indicate that the target ESC is addressed. The ESC may also need to record the target addressing number to accurately respond to instructions associated with the UAV flight sent subsequently by the flight controller.

In some embodiments, the method may further include, before the ESC obtains the addressing instruction of the flight controller, the ESC obtaining installation information of ESC and sending the installation information to the flight controller. The method may further include, before the flight controller sends the throttle characteristic signal to the ETBA target ESC, the flight controller receiving the installation information sent from the electric speed controller.

In some embodiments, since a newly assembled ESC may contain no addressing number before the UAV is initially powered on. Thus, the flight controller may need to receive the installation information of the ESC, such that the throttle characteristic signal can be accurately sent to the target ESC. In some embodiments, the ESC may inform the flight controller of the installation information. In some other embodiments, the user may import the installation information of the ESC in the flight controller after the ESC is assembled. How the flight controller receives the installation information is not restricted in the present disclosure, and may be chosen according various application scenarios.

The installation information of the ESC may include at least one of an installation position, a product model number, or an operation pulse width range. The installation position may refer to a position associated with a motor connected to the ESC after the ESC is assembled. The product model number and the operation pulse width range may determine a generated throttle characteristic signal. For example, an operation pulse width range of the electric speed controller during a normal operation may include a range of approximately 1000 us to approximately 2000 us of high electric level time duration of the PWM signal, and the throttle characteristic signal may not be in the operation pulse width range.

According to above-described embodiments associated with installation information, the flight controller may need to use the installation information of the ESC for determining the ETBA target ESC. Processes of determining the target electric speed controller and generating the throttle characteristic signal are described below in further detail.

In some embodiments, the flight controller determining the ETBA target ESC may include obtaining the installation information of the ETBA target ESC; and determining the target ESC according to the installation information of the target ESC.

In some embodiments, the flight controller may obtain the installation information of the ETBA target ESC, and accurately locate the ETBA target ESC according to the installation information.

In some embodiments, the flight controller generating the throttle characteristic signal may include setting characteristic information of the throttle characteristic signal in a preset range; and generating the throttle characteristic signal according to the characteristic information of the throttle characteristic signal.

In some embodiments of the present disclosure, the flight controller may set the characteristic information of the throttle characteristic signal within a preset range, such that the throttle characteristic signal can be generated according to the characteristic information. According to the above-described examples, when the electric speed controller operates normally, the signal may include a PWM signal having a fixed frequency and a variable time duration of high electric level. The time duration of high electric level may usually range from approximately 1000 μs to approximately 2000 μs. The longer the high electric level pulse width, the faster the ESC drives the rotation of the motor. In some embodiments, characteristic information of the throttle characteristic signal may include the time duration of high electric level. In order to prevent the ESC from driving the motor during addressing, the high electric level time duration of the throttle characteristic signal may not be between approximately 1000 μs and approximately 2000 μs. For example, the preset range may be less than 1000 μs. Further, the characteristic information of the throttle characteristic signal may be set to, for example, approximately 500 μs, approximately 100 μs, or another value that is less than approximately 1000 μs.

The characteristic information of the above-described throttle characteristic signal is described taking a high electric level time duration as an example, merely for illustrative purposes. In the present disclosure, the characteristic information may include at least one of a signal frequency, a signal time, e.g., a signal time duration, or a signal amplitude.

In various application scenarios, the flight controller may send the throttle characteristic signal by using the PWM signal line as the throttle control signal line. Thus, the throttle characteristic signal may include a PWM signal. When the ESC operates normally, a PWM signal may have a fixed frequency, and a variable high electric level time duration, and a preset operation pulse width range may usually range from approximately 1000 μs to approximately 2000 μs. The longer the high electric level pulse width, the faster the ESC drives the rotation of the motor. Thus, characteristic information of the throttle characteristic signal may include the high electric level pulse width, i.e., the time duration of high electric level. In order to prevent the ESC from driving the motor during addressing, the high electric level time duration of the throttle characteristic signal may not be between approximately 1000 μs and approximately 2000 μs.

In the above-described embodiments, the concept of the characteristic information of the throttle characteristic signal is introduced. The electric speed controller may determine whether the throttle characteristic signal is received according to the characteristic information, which is described below.

In some embodiments, determining whether the throttle characteristic signal is received may include receiving a throttle signal through a throttle signal interface of the electric speed controller; obtaining characteristic information of the throttle signal; and determining whether the throttle signal is the throttle characteristic signal according to the characteristic information.

In some embodiments, the ESC may receive a throttle signal through a throttle signal interface, analyze the throttle signal to obtain characteristic information of the throttle signal. Because characteristic information of the throttle characteristic signal may have been processed by the flight controller, a difference may exist between the characteristic information of the throttle characteristic signal and the characteristic information of the throttle signal during operation, also referred to as an “operation throttle signal.” Thus, it may be determined whether the throttle signal is the throttle characteristic signal according to the characteristic information, thereby determining whether the throttle characteristic signal is received.

In some embodiments, determining whether the throttle signal is the throttle characteristic signal according to the characteristic information may include determining whether the characteristic information is in a preset range; in response to the characteristic information being in the preset range, determining that the throttle signal is the throttle characteristic signal; and in response to the characteristic information being not in the preset range, determining that the throttle signal is not the throttle characteristic signal.

In some embodiments, throttle signals sent through the communications between the flight controller and the ESC may be used for a normal operation of the ESC or for addressing. A preset range of the characteristic information of the throttle characteristic signal and a preset range of the characteristic information of the throttle signal during the normal operation of the ESC may be separated to distinguish the throttle characteristic signal from the throttle signal. For example, the throttle signal and the throttle characteristic signal both may be PWM signals. The PWM signals may have fixed frequencies and variable high electric level time durations. A preset operation high electric level pulse width may generally range from approximately 1000 μs to approximately 2000 μs. Thus, a high electric level pulse width of the throttle characteristic signal may be taken as the characteristic information of the throttle characteristic signal, and the high electric level pulse width of the throttle characteristic signal may be outside the range of approximately 1000 μs to approximately 2000 μs. Changing the high electric level pulse width may be relatively easy to operate and achieve.

In some embodiments, the method may further include, after recording the target addressing number, sending a prompt instruction for controlling a prompt apparatus to generate prompt information.

In some embodiments, after the ESC performs addressing and records a target addressing number, the ESC may control a prompt apparatus to generate prompt information for indicating that the ESC side is completed. Further, for the flight controller side, an alarm may be sent, in response to the flight controller not receiving the feedback information. Accordingly, it may be identified whether there is device problem(s) with the electric speed controller, or a connection problem between the ESC and the flight controller, such as reversed communication interface and throttle control interface, a connection line fracture, or other issues.

The above-described prompt apparatus and the alarm apparatus may include, for example, a buzzer. The buzzer may be integrated in the flight controller and/or the ESC, or arranged separately. The above-described prompt apparatus and the alarm apparatus may include, for example, a power motor of the UAV. The ESC and the flight controller may control the power motor to vibrate to generate sounds or rotate to indicate prompt information or alarm information.

In the above-described embodiments, the control method of the ESC and the flight controller are described through an interaction manner of the ESC and the flight controller. A control system of the ESC and a control system of the flight controller are described below.

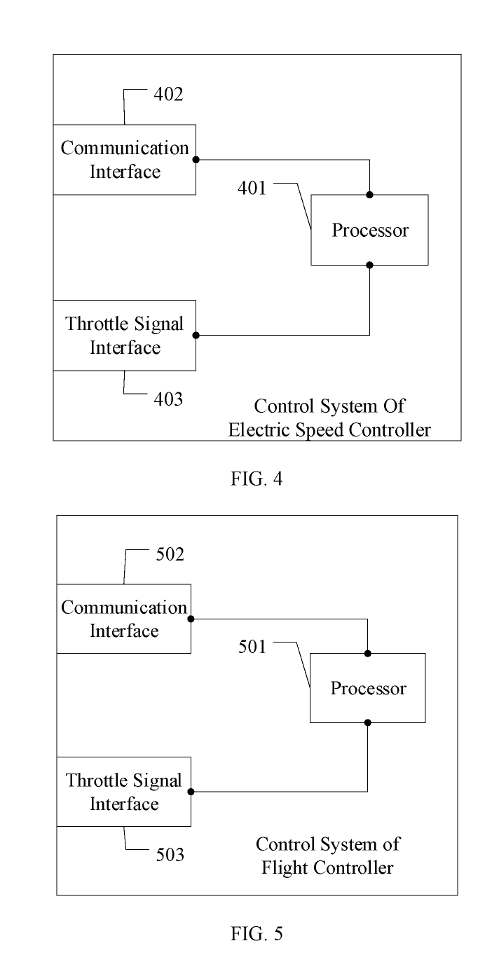

FIG. 4 is a block diagram of an exemplary control system of ESC consistent with various disclosed embodiments of the present disclosure. As shown in FIG. 4, the control system of ESC, also referred to as an “ESC control system,” includes one or more processors 401 operating separately or collectively. The processor(s) 401 are configured to obtain the addressing instruction of the flight controller, where the addressing instruction is used for addressing the ESC such that the ESC is assigned with a target addressing number; determine whether a throttle characteristic signal is received; and in response to the throttle characteristic signal being received, send a feedback signal for responding to the addressing instruction, and record a target addressing number according to the addressing instruction.

In some embodiments, the processor 401 in the ESC control system may be single-core or multi-core. In some embodiments, one processor 401 may operate alone. In some other embodiments, a plurality of processors 401 may operate together. The processor 401 may be configured to obtain an addressing instruction of the flight controller and determine whether the throttle characteristic signal is received. In response to the throttle characteristic signal being received, the processor 401 may send a feedback signal for responding to the addressing instruction and record a target addressing number according to the addressing instruction. As compared to conventional technologies, the ESC of the present disclosure may perform addressing according to the addressing instruction of the flight controller without a need to install a numbered ESC to a corresponding motor position. Accordingly, safety hazard in UAV caused by installation of the ESC may be suppressed, the installation of ESCs during UAV manufacturing, assembling and repairing processes may be relatively convenient.

In some embodiments, as shown in FIG. 4, the control system of the ESC further includes a communication interface 402 and a throttle signal interface 403.

The processor(s) 401 may be connected to the flight controller through the communication interface 402, and receive an addressing instruction and send a feedback signal through the communication interface 402.

The processor(s) 401 may be connected to the flight controller through the throttle signal interface 403, and receive the throttle characteristic signal through the throttle signal interface 403.

In some embodiments, the communication interface 402 of the ESC control system may be connected to the flight controller through the UART communication line, and the throttle signal interface 403 of the ESC control system may be connected to the flight controller through the throttle control signal line. The processor(s) 401 may be connected to the flight controller through the communication interface 402 to receive the addressing instruction and send the feedback information. The processor(s) 401 may be further connected to the flight controller through the throttle signal interface 403 to receive throttle characteristic signal. In some embodiments, the communication interface 402 may be connected to a bus-type UART communication line, while the throttle control signal line connected to the throttle signal interface 403 may be connected to the flight controller separately. Thus, addressing may be performed on the plurality of ESCs one by one.

In some embodiments, the processor(s) 401 may be further configured to perform addressing according to the throttle characteristic signal to obtain the target addressing number; generate a feedback signal according to the addressing instruction; send the feedback signal to the flight controller; and record the target addressing number.

In some embodiments, after the processor(s) 401 receive the throttle characteristic signal, which indicates that the ESC is the target ESC, the addressing instruction received previously may need to be executed to perform addressing and to obtain a target addressing number of the ESC. Further, during addressing, a feedback signal may need to be generated, and may need to be sent to the flight controller through the UART communication line, to indicate that the target ESC has been addressed. Further, the ESC may need to record the target addressing number to accurately respond to instructions associated with the UAV flight sent subsequently by the flight controller.

In some embodiments, the processor(s) 401 may be further configured to receive a throttle signal through the throttle signal interface of the ESC; obtain characteristic information of the throttle signal; and determine whether the throttle signal is a throttle characteristic signal according to the characteristic information.

In some embodiments, the processor(s) 401 may receive a throttle signal through the throttle signal interface 403, analyze the throttle signal to obtain characteristic information of the throttle signal. Because characteristic information of the throttle characteristic signal has been processed by the flight controller, a difference may exist between the characteristic information of the throttle characteristic signal and the characteristic information of the throttle signal during operation. Thus, the processor 401 may determine whether the throttle signal is the throttle characteristic signal according to the characteristic information, thereby determining whether the throttle characteristic signal is received.

In some embodiments, the characteristic information of the throttle signal may include at least one of a signal frequency, a signal time, or a signal amplitude.

In some embodiments, the processor(s) 401 may be further configured to determine whether the characteristic information is in a preset range; in response to the characteristic information being in the preset range, determine that the throttle signal is a throttle characteristic signal; and in response to the characteristic information being not within the preset range, determine that the throttle signal is not a throttle characteristic signal.

In the embodiments of the present disclosure, throttle signals sent through the communications between the flight controller and the processor(s) 401 may be used for a normal operation of the ESC or for addressing. A preset range of the characteristic information of the throttle characteristic signal and a preset range of the characteristic information of the throttle signal during the normal operation of the ESC may be separated to determine whether the throttle signal is the throttle characteristic signal. For example, throttle signal and throttle characteristic signal both may be PWM signals. The PWM signals may have fixed frequencies and variable high electric level time duration. A preset operation high electric level pulse width may generally range from approximately 1000 μs to approximately 2000 μs. Thus, a high electric level pulse width of the throttle characteristic signal may be taken as the characteristic information, and the high electric level pulse width of the throttle characteristic signal may be outside the range of approximately 1000 μs to approximately 2000 μs. Changing the high electric level pulse width may be relatively easy to operate and achieve.

In some embodiments, the throttle signal and the throttle characteristic signal may both be pulse width modulation (PWM) signals.

In some embodiments, characteristic information of the PWM signal may include a high electric level pulse width, also referred to as “a high electric level pulse width value,” and the high electric level pulse width may not be in a preset operation pulse width range of the ESC.

In some embodiments, the ESC control system may further include a prompt apparatus (not shown).

The prompt apparatus may be configured to generate prompt information according to a prompt instruction sent by the processor(s) 401.

In some embodiments, the prompt apparatus may include a buzzer, and the processor(s) 401 may control the buzzer to generate a prompt sound.

In some embodiments, the buzzer may be arranged in the ESC or arranged separately.

In some embodiments, the prompting apparatus may include a power motor of the UAV, and the ESC may control the power motor to vibrate to produce sounds or rotate to indicate the prompt information.

In some embodiments, the processor(s) 401 may be further configured to delete, in response to determining that the throttle characteristic signal is not received, the addressing instruction.

In some embodiments, in response to the processor(s) 401 determining that the throttle characteristic signal is not received, which may indicate that the ESC is not the target ESC, the previously received addressing instruction may not be executed. In order to reduce the memory occupation of the ESC, the processor(s) 401 may delete the addressing instruction.

In some embodiments, the processor(s) 401 may be further configured to obtain installation information of the ESC and send the installation information to the flight controller.

In some embodiments, since a newly assembled ESC has no addressing number before the UAV is initially powered on, the flight controller may need to receive the installation information of the ESC, such that the throttle characteristic signal can be accurately sent to the target ESC.

In some embodiments, the installation information of the ESC may include at least one of an installation location, a product model number, or an operation pulse width range.

FIG. 5 is a block diagram of an exemplary control system of flight controller consistent with various disclosed embodiments of the present disclosure. As shown in FIG. 5, the control system of the flight controller, also referred to as a “flight controller control system,” includes one or more processors 501 operating separately or collectively. The processor(s) 501 are configured to send addressing instructions to the ESCs, where the addressing instructions are used for addressing the ESCs such that the ESCs are assigned with target addressing numbers; send a throttle characteristic signal to an ETBA target electric speed controller; determine whether a feedback signal sent from the target ESC is received; and in response to the feedback signal being received, register the addressing number of the target ESC as a target addressing number.

In some embodiments, the processor(s) 501 of the control system of the flight controller may be single-core or multi-core. In some embodiments, one processor 501 may operate alone. In some other embodiments, a plurality of processors 501 may operate together. The processor(s) 501 may be configured to send addressing instructions to the ESCs; send a throttle characteristic signal to an ETBA target ESC; determine whether a feedback signal sent from the target ESC is received; in response to receiving the feedback signal, register an addressing number of the target ESC as a target addressing number. As compared to conventional technologies, the flight controller of the present disclosure may control a target ESC that has not performed addressing to perform addressing without a need to install a numbered ESC to a corresponding motor position. Accordingly, safety hazard in UAV caused by installation of the ESC may be suppressed, and the installation of ESCs during UAV manufacturing, assembling, and repairing processes may be relatively convenient.

In some embodiments, as shown in FIG. 5, the control system of the flight controller further includes a communication interface 502 and a throttle signal interface 503.

The processor(s) 501 may be connected to the ESCs through the communication interface 502 for sending addressing instructions and receiving feedback signals.

The processor(s) 501 may be connected to the ESCs through the throttle signal interface 503 for sending the throttle characteristic signal.

In some embodiments, the communication interface 502 of the control system of the flight controller may be connected to an ESC through an UART communication line, and the throttle signal interface 503 may be connected to an ESC through the throttle control signal line. The processor(s) 501 may be connected to the ESC through the communication interface 502 to send an addressing instruction and receive a feedback signal. The processor(s) 501 may be connected to the ESC through the throttle signal interface 503 to send the throttle characteristic signal. Since the communication interface 502 is connected to a bus-type UART communication line, and the throttle control signal line connected to the throttle signal interface 503 is connected to the ESC separately, addressing may be performed on the plurality of the ESCs one by one.

In some embodiments, the processor(s) 501 may be further configured to determine an ETBA target ESC; and generate a throttle characteristic signal and send the throttle characteristic signal to the target ESC.

In the embodiments of the present disclosure, since the throttle control signal line between the processor 501 and the ESC is not in a form of a bus, when the processor(s) 501 send the throttle characteristic signal, the processor(s) 501 may further need to determine an ETBA target ESC for sending accurately.

In some embodiments, the processor(s) 501 may be further configured to receive installation information of the ESC.

In some embodiments, since a newly assembled ESC has no addressing number before the UAV is initially powered on, the processor 501 may need to receive the installation information of the ESC, such that the throttle characteristic signal can be accurately sent to the target ESC.

In some embodiments, the ESC installation information may include at least one of an installation location, a product model number, or an operation pulse width range.

In some embodiments, the processor(s) 501 may be further configured to obtain installation information of the ETBA target ESC; and determine the target ESC according to the installation information of the target ESC.

In some embodiments, the processor(s) 501 may obtain the installation information of the ETBA target ESC, and accurately locate the ETBA target ESC according to the installation information.

In some embodiments, the processor(s) 501 may be further configured to set characteristic information of the throttle characteristic signal in a preset range; and generate the throttle characteristic signal according to the characteristic information of the throttle characteristic signal.

In some embodiments, the processor(s) 501 may set characteristic information of the throttle characteristic signal in a preset range, such that the throttle characteristic signal can be generated according to the characteristic information. According to the above-described examples, when the ESC operates normally, the signal may include a PWM signal having a fixed frequency and a variable time duration of high electric level. The time duration of high electric level may usually range from approximately 1000 μs to approximately 2000 μs. The longer the high electric level pulse width, the faster the ESC drives the rotation of the motor. Thus, characteristic information of the throttle characteristic signal may include the time duration of high electric level. In order to prevent the ESC from driving the motor during addressing, The time duration of high electric level of the throttle characteristic signal may not be between approximately 1000 μs and approximately 2000 μs. For example, a preset range may be less than 1000 μs. Further, the characteristic information of the throttle characteristic signal may be set to, for example, approximately 500 μs, approximately 100 μs, or another value of less than approximately 1000 μs.

In some embodiments, the characteristic information of the throttle characteristic signal may include at least one of a signal frequency, a signal time, or a signal amplitude.

In some embodiments, the throttle characteristic signal may include a PWM signal.

In some embodiments, the characteristic information of the PWM signal may include a high electric level pulse width, also referred to as “a high electric level pulse width value,” and the high electric level pulse width may not be in a preset operation pulse width range of the ESC.

In some embodiments, the processor(s) 501 may be further configured to send, in response to determining that the feedback signal sent from the target ESC is not received, an alarm instruction for controlling an alarm apparatus to send alarm information.

In some embodiments, the processor(s) 501 not receiving a feedback signal from the target ESC may indicate that the addressing of the target ESC fails. Correspondingly, the UAV may be in danger. The processor(s) 501 may need to send an alarm instruction for controlling an alarm apparatus to send alarm information, to prompt the user that there is danger at this time and the UAV cannot be operated for flight.

In some embodiments, the processor(s) 501 may be further configured to send a prompt instruction for controlling a prompt apparatus to generate prompt information.

In some embodiments, after the processor(s) 501 registers a target addressing number of the target ESC, the processor(s) 501 may send a prompt instruction for controlling the prompt apparatus to generate prompt information to prompt that addressing for the target ESC is completed.

In some embodiments, the alarm apparatus and the prompt apparatus may include one or more buzzers, and the flight controller may control the buzzer to generate a prompt sound.

In some embodiments, the buzzer may be arranged in the flight controller or arranged separately.

In some embodiments, the alarm apparatus and the prompt apparatus may include a power motor of the UAV, and the flight controller may control the power motor to vibrate to produce a sound or rotate to indicate alarm information and/or prompt information.

In the above-described embodiments, the control method and the control system of the ESC and the flight controller are described. The ESC and the flight controller are separately described below.

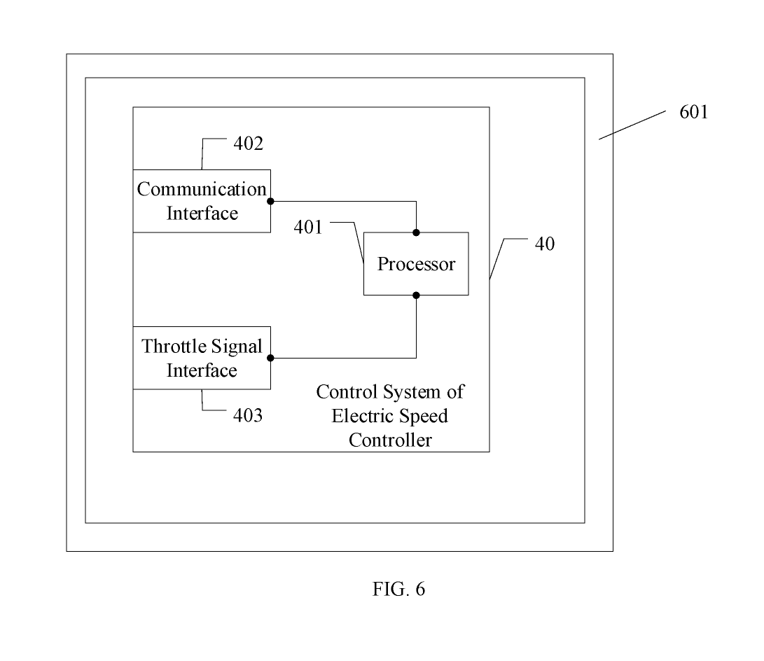

FIG. 6 is a block diagram of an exemplary ESC consistent with various disclosed embodiments of the present disclosure.

As shown in FIG. 6, the ESC includes a housing 601 and an ESC control system 40, such as the ESC control system shown in FIG. 4.

The ESC control system 40 is arrange inside the housing 601.

The ESC control system 40 includes the one or more processors 401 operating separately or collectively. The processor(s) 401 are configured to obtain the addressing instruction of the flight controller, where the addressing instruction is used for addressing the ESC, such that the ESC is assigned with a target addressing number; to determine whether a throttle characteristic signal is received. Further, in response to the throttle characteristic signal being received, the ESC, e.g., via the processor(s) 401, may send a feedback signal for responding to the addressing instruction to the flight controller, and record the target addressing number according to the addressing instruction.

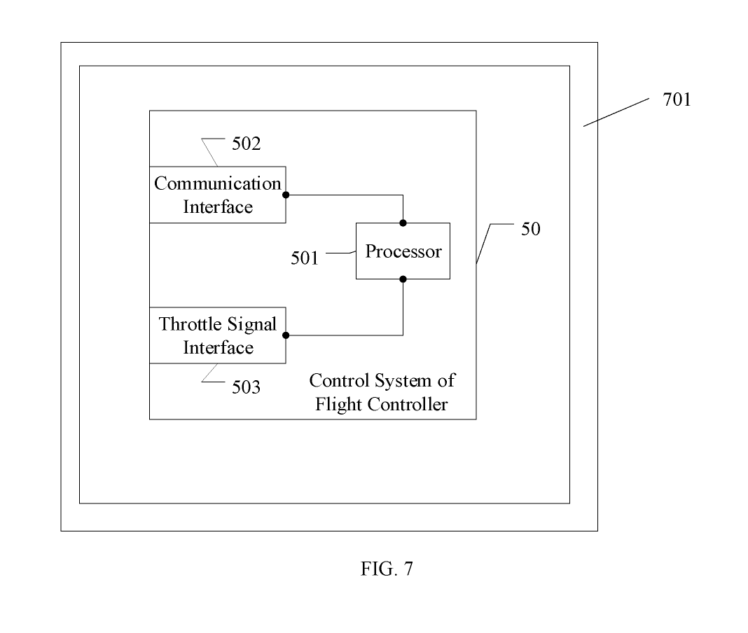

FIG. 7 is a block diagram of an exemplary flight controller consistent with various disclosed embodiments of the present disclosure.

As shown in FIG. 7, the flight controller includes a housing 701 and a control system 50 of the flight controller, such as the control system shown in FIG. 5.

The control system 50 of the flight controller is arranged in the housing 701.

The control system 50 includes the one or more processors 501 operating separately or collectively. The processor(s) 501 are configured to send addressing instructions to the ESCs, where the addressing instructions are used for addressing the ESCs, such that the ESCs are assigned with target addressing numbers; send a throttle characteristic signal to an ETBA target ESC; determine whether a feedback signal sent from the target ESC is received. Further, in response to the feedback signal being received, the flight controller, e.g., via the processor(s) 501, registers the addressing number of the target ESC as a target addressing number.

The control system of UAV is described below in conjunction with the ESC and the flight controller shown in FIGS. 6 and 7.

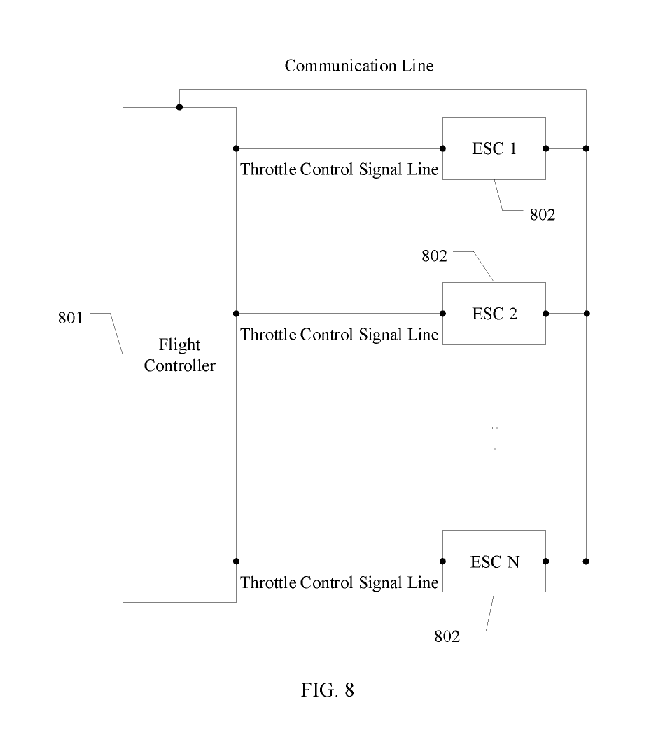

FIG. 8 is a block diagram of an exemplary control system of UAV consistent with various disclosed embodiments of the present disclosure. As shown in FIG. 8, the control system of UAV, also referred to as a “UAV control system,” includes a flight controller 801 and at least one ESC 802 electrically connected to the flight controller 801.

The flight controller 801 may send a throttle characteristic signal through a throttle control signal line and an addressing instruction to the ETBA target ESC 802. After receiving the throttle characteristic signal, the target ESC 802 may perform addressing according to the addressing instruction, generate a feedback signal, and obtain and record a target addressing number. The flight controller 801 may receive a feedback signal, and register an addressing number of the target ESC 802 as a target addressing number according to the feedback signal.

In some embodiments, the flight controller 801 can address the ESC 802 at a later stage without the need to install a numbered ESC to a corresponding motor position, thereby suppressing potential safety hazard of the UAV caused by ESC installation. Further, installation of ESCs during UAV manufacturing, assembling and repairing processes may be relatively convenient.

Based on the above-described UAV control system, the UAV control method implemented in the UAV control system is described below.

The flight controller sends an addressing instruction to at least one ESC through a bus. The addressing instruction is used for addressing one of the at least one ESC with a target addressing number.

The flight controller sends a throttle characteristic signal to an ETBA target ESC through a throttle control signal line.

The target ESC receives the throttle characteristic signal sent from the flight controller, and performs addressing according to the throttle characteristic signal and the addressing instruction to generate a feedback signal, and obtains and records a target addressing number.

The target ESC returns the feedback signal to the flight controller.

The flight controller receives the feedback signal sent from the target ESC and registers the addressing number of the target ESC as the target addressing number according to the feedback signal.

In some embodiments, the flight controller can address the ESC that has not been addressed at a later stage without the need to install a numbered ESC to a corresponding motor position, thereby avoiding potential safety hazard of the UAV caused by ESC installation. Further, installation of ESCs during UAV manufacturing, assembling and repairing may be relatively convenient.

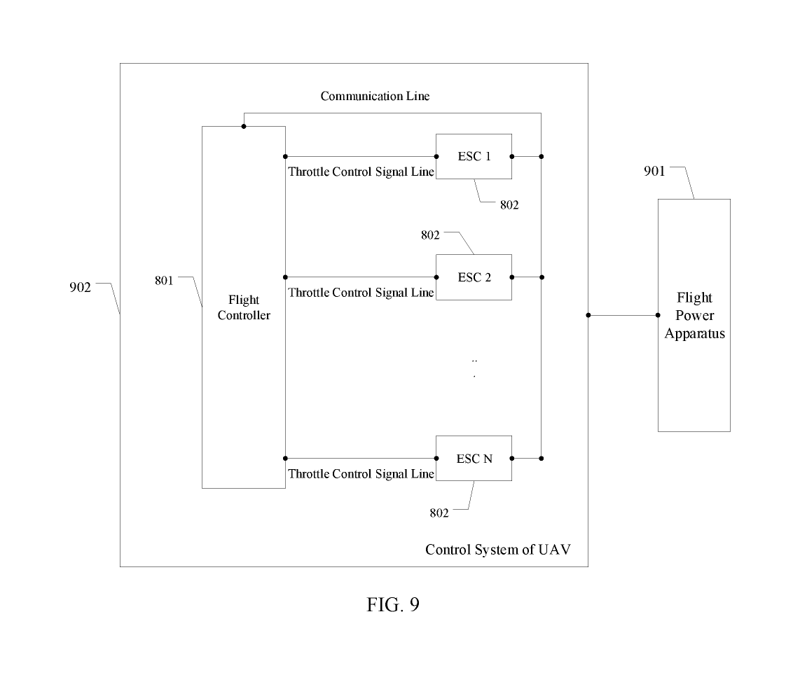

FIG. 9 is a block diagram of an exemplary UAV consistent with various disclosed embodiments of the present disclosure.

As shown in FIG. 9, the UAV includes a flight power apparatus 901 and a UAV control system 902, such as the UAV control system shown in FIG. 8.

The UAV control system 902 is configured to control the flight power apparatus 901 to provide flight power for the UAV.

In some embodiments, the flight power apparatus 901 may generally include at least one motor and at least one propeller. The motor may drive the propeller to rotate by using the flight controller and the ESC in the UAV control system 902 to control a rotation speed of the motor.

The present disclosure provides an electric speed controller, a flight controller, an unmanned aerial vehicle (UAV) control method, and a UAV control system, for suppressing potential safety hazard of the UAV caused by ESC installation and for relatively convenient installation of ESCs during UAV manufacturing, assembling and repairing processes. In the UAV control method, a flight controller may send addressing instructions to ESCs, where the addressing instructions may be used for addressing the ESCs, such that the ESCs may be assigned with target addressing numbers. The ESCs may receive the addressing instructions from the flight controller. The flight controller may send a throttle characteristic signal to an ETBA target ESC. The ESC may determine whether the throttle characteristic signal is received. In response to the ESC receiving the throttle characteristic signal, the ESC may send a feedback signal for responding to the addressing instruction to the flight controller, and record a target addressing number according to the addressing instruction. The flight controller may determine whether the feedback signal sent from the target ESC response is received. In response to the flight controller receiving the feedback signal, the flight controller may register the addressing number of the target ESC as a target addressing number.

For the above-described method embodiments, for ease of description, the method embodiments are described as a plurality of operation combinations. Those skilled in the art would understand that the present disclosure is not limited to sequences of operations described, and in the present disclosure, some processes may be performed in other sequences or performed simultaneously. Those skilled in the art would also understand that the above-described embodiments are some of embodiments, and actions and circuits involved are not necessarily needed in the present disclosure.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computing device, such as a processor, a personal computer, a server, or a network device, to perform part or all of a method consistent with the disclosure, such as one of the exemplary methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A method for controlling an electric speed controller comprising:
receiving an addressing instruction from a flight controller, the addressing instruction being used for addressing the electric speed controller with a target addressing number;
determining whether a throttle characteristic signal is received; and
in response to determining that the throttle characteristic signal is received, sending a feedback signal for responding to the addressing instruction, and recording the target addressing number according to the addressing instruction.

2. The method according to claim 1, further comprising:
performing addressing according to the throttle characteristic signal to obtain the target addressing number; and
generating the feedback signal according to the addressing instruction.

3. The method according to claim 1, wherein determining whether the throttle characteristic signal is received includes:
receiving a throttle signal through a throttle signal interface of the electric speed controller;
obtaining characteristic information of the throttle signal; and
determining whether the throttle signal is the throttle characteristic signal according to the characteristic information.

4. The method according to claim 3, wherein the characteristic information of the throttle signal includes at least one of a signal frequency, a signal time, or a signal amplitude.

5. The method according to claim 3, wherein determining whether the throttle signal is the throttle characteristic signal according to the characteristic information includes:
determining whether the characteristic information is in a preset range;
determining that the throttle signal is the throttle characteristic signal in response to determining that the characteristic information is in the preset range; and
determining that the throttle signal is not the throttle characteristic signal in response to determining that the characteristic information is not in the preset range.

6. The method according to claim 5, wherein the throttle signal and the throttle characteristic signal include pulse width modulation signals.

7. The method according to claim 6, wherein:
characteristic information of the pulse width modulation signal includes a high electric level pulse width, and
the preset range is outside a preset operation pulse width range of the electric speed controller.

8. The method according to claim 2, further comprising, after recording the target addressing number:
sending a prompt instruction for controlling a prompt apparatus to generate prompt information.

9. The method according to claim 8, wherein:
the prompt apparatus includes a buzzer, and
the prompt instruction controls the buzzer to generate a prompt sound.

10. The method according to claim 9, wherein:
the buzzer is arranged in the electric speed controller or arranged separately.

11. The method according to claim 8, wherein:
the prompt apparatus includes a power motor of an unmanned aerial vehicle, and
the prompt instruction controls the power motor to vibrate to produce a sound or to rotate, to indicate the prompt information.

12. The method according to claim 1, further comprising:
deleting the addressing instruction in response to determining that the throttle characteristic signal is not received.

13. The method according to claim 1, further comprising, before receiving the addressing instruction from the flight controller:
obtaining installation information of the electric speed controller; and
sending the installation information to the flight controller.

14. The method according to claim 13, wherein the installation information includes at least one of an installation position, a product model number, or an operation pulse width range.

15. A control method for a flight controller comprising:
sending one or more addressing instructions to one or more electric speed controllers, respectively, the one or more addressing instructions being used for addressing the one or more electric speed controllers with one or more target addressing numbers, respectively;
sending a throttle characteristic signal to a target electric speed controller of the one or more electric speed controllers that is expected to be addressed;
determining whether a feedback signal sent from the target electric speed controller is received; and
in response to determining that the feedback signal is received, registering an addressing number of the target electric speed controller as one of the one or more target addressing numbers.

16. The method according to claim 15, wherein sending the throttle characteristic signal to the target electric speed controller includes:
determining the target electric speed controller from the one or more electric speed controllers; and
generating the throttle characteristic signal and sending the throttle characteristic signal to the target electric speed controller.

17. The method according to claim 16, further comprising, before sending the throttle characteristic signal to the target electric speed controller:
receiving installation information of the one or more electric speed controllers.

18. The method according to claim 17, wherein the installation information includes at least one of an installation position, a product model number, or an operation pulse width range.

19. The method according to claim 17, wherein determining the target electric speed controller includes:
obtaining the installation information of the target electric speed controller; and
determining the target electric speed controller according to the installation information of the target electric speed controller.

20. The method according to claim 15, wherein generating the throttle characteristic signal includes:
setting characteristic information of the throttle characteristic signal in a preset range; and
generating the throttle characteristic signal according to the characteristic information of the throttle characteristic signal.
